(19) United States
(12) Patent Application Publication
(10) Pub. No.: US 2025/0112507 A1
(43) Pub. Date: Apr. 3, 2025

(54) ELECTRIC MOTOR FOR AN ACTUATOR AND AN ACTUATOR WITH SUCH AN ELECTRIC MOTOR

(71) Applicant: HELLA GMBH & CO. KGAA, Lippstadt (DE)

(72) Inventors: Bodo Buecker, Arnsberg (DE); Matthias Humpe, Oelde (DE); Jost Kleine-Weischede, Kamen (DE); Sven Rappold, Geseke (DE); Christoph Schulte, Paderborn (DE); Katrin Zimmermann, Soest (DE)

(21) Appl. No.: 18/903,116

(22) Filed: Oct. 1, 2024

(30) Foreign Application Priority Data
Oct. 2, 2023 (DE) 102023126792.2

(51) Int. Cl. H02K 1/14; H02K 1/2706; H02K 7/116

(52) U.S. Cl. CPC H02K 1/145; H02K 1/2706; H02K 7/116

(57) ABSTRACT

An electric motor is proposed for an actuator. The electric motor comprises a stator with a ring and a plurality of electromagnets, each of which has a coil core and a coil wound around the corresponding coil core, a rotor with a rotor axis arranged in the stator, and a bearing with a bearing axis for a gearwheel. The electromagnets are arranged next to one another on a circular path, wherein the circular path has at least one circular arc opening. The bearing axis is arranged in the at least one circular arc opening parallel to the rotor axis.

### CROSS-REFERENCE TO RELATED APPLICATIONS

The present application claims the benefit of German Patent Application No. 10-2023-126-792.2, filed Oct. 2, 2023, the disclosure of which is incorporated by reference.

### FIELD OF THE INVENTION

The invention relates to an electric motor for an actuator and such an actuator.

### BACKGROUND OF THE INVENTION

Electric motors are known per se and are used, e.g. in motor vehicles, in many ways for many different purposes, e.g. as a servo motor.

A flat electric motor, which is formed especially for applications in the area of medical devices is known from WO2015/074940. This specification aims to provide an electric motor with a high efficiency.

A multiphase electric motor, especially a multiphase electric motor for the applications of electrically controlling mechanical components, such as motor vehicle clutches, as a replacement for hydraulic or pneumatic control solutions is known from WO2021/116029.

For the electrification of up until now hydraulic or pneumatic controls, powerful, robust, space-saving and compact actuators are needed.

A space-saving electric motor is known from DE 10-2021-119-817, which, however, takes up more space in height than other known electric motors.

### SUMMARY OF THE INVENTION

It is therefore the object of the present invention to provide an electric motor for an actuator, which, while being sufficiently powerful, requires as little space as possible in all three spatial directions, and simultaneously enables a high freedom of design for an assigned gearbox. This object is achieved through the electric motor described herein. With the embodiments of the invention, an improved electric motor may advantageously be provided. With such an electric motor, space can be saved efficiently in the corresponding application, especially space in the height of the electric motor, without having to sacrifice much power.

A first aspect of the present disclosure relates to an electric motor for an actuator. The electric motor comprises a stator with a ring and a plurality of electromagnets, each of which has a coil core and a coil wound around the corresponding coil core. The electric motor further comprises a rotor arranged in the stator with a rotor axis and a bearing with a bearing axis for a gearwheel. The plurality of electromagnets are arranged next to one another on a circular path. The circular path has at least one circular arc opening. The bearing axis is arranged in parallel to the rotor axis in said at least one circular arc opening.

In other words, an electromagnet or multiple electromagnets may be omitted to use the space, that is taken up by said one electromagnet or multiple electromagnets, to arrange the bearing axis in it. Thus the distance in the radial direction between the bearing axis and the rotor axis may be smaller than the radius of the stator ring. One electromagnet and/or only one coil may be omitted. In other words, the electromagnets may be arranged in such a manner that they form an open circle, wherein the opening of the circle is formed through a distance, in the circumferential direction, between the two electromagnets and/or coils, larger than the distance between the other electromagnets and/or coils.

In the context of the present disclosure, the bearing for a gearwheel may be a non-rotating shaft which is fastened to the stator and onto which the gearwheel is rotatably placed, or a bearing bushing for a shaft rigidly connected to the gearwheel.

In the context of the present disclosure, the term bearing may be interpreted broadly. A bearing may accordingly denote a receptacle for an axis.

Through that it can be achieved that the bearing axis can receive a smaller gearwheel than known electric motors, and that the electric motor as a whole has a smaller height or takes up less space in the Z-direction than known electric motors, wherein the Z-direction runs parallel to the rotor axis.

According to an embodiment of the electric motor, the at least one circular arc opening has a circular arc length which corresponds to the tangential width of at least one coil, especially exactly one coil or exactly two coils. In other words, exactly one coil or two coils with or without the corresponding coil core can be omitted in order to create space for the bearing with the bearing axis.

Through that, a more compact electric motor can be provided without excessive reduction or detriment of the power of the electric motor.

The tangential width, in the context of the present disclosure, is preferably the circular arc length of a coil or the largest width of a coil. As a rule, one coil has a truncated cone shape, wherein the coil is arranged to be wound around a coil core. Accordingly, the core preferably has a hole.

The coil may especially be formed as a truncated pyramid, wherein the edges of the truncated pyramid are rounded. The tangential width of a coil may therefore describe the diameter or the base area of the truncated cone or the truncated pyramid of the coil. It should be noted that the sheath line of the coil or trunk is directed or points towards the center of the ring of the stator.

According to an embodiment of the electric motor, the electric motor further has at least one coil core without a coil. The at least one coil core without a coil is arranged in the at least one circular arc opening. In other words, it may be provided to omit only the coil of the corresponding electromagnet. This can especially simplify the production of the electric motor, since no change in the manufacturing of the ring is required (in comparison to electromagnets with a stator, which are arranged on a complete circular path).

According to an embodiment of the electric motor, the at least one coil core without a coil has the same distance to the neighboring coil cores as the distance between two coil cores of the plurality of electromagnets.

According to an embodiment of the electric motor, the rotor axis coincides with the center point of the stator ring.

According to an embodiment of the electric motor, the plurality of coil cores of the electromagnets and/or the at least one coil core without a coil are pointing radially inwards.

According to an embodiment of the electric motor, the stator ring is formed monolithically with the coil cores of the electromagnets and especially with the at least one coil core without a coil. The stator ring may be referred to as iron ring. The coil cores may be formed as a ridge.

According to an embodiment of the electric motor, the circular path has two circular arc openings. The two circular arc openings are arranged opposite one another in a radial direction.

According to an embodiment of the electric motor, the stator is encapsulated with a sheath, especially a sheath containing plastics. Additionally, the bearing for the assigned gearwheel is formed with the encapsulation.

According to an embodiment of the electric motor, the electric motor further has at least one gearwheel. The gearwheel can, in comparison to the gearwheels of the known electric motors, have a smaller diameter, through which the electric motor can be formed more compactly.

According to an embodiment of the electric motor, the drive end of the rotor is formed as a pinion. Additionally, the pinion is engaged with a/the gearwheel.

According to an embodiment of the electric motor, the rotor is arranged rotatably in the stator and has a multipolar permanent magnet. The rotor is preferably located in the housing. The bearing of the rotor can be formed e.g. with an encapsulation. Alternatively, the bearing can be formed by the housing itself (not encapsulated).

Another aspect of the present invention relates to an actuator, which has an electric motor as described above and below, and a gearbox.

It should be noted that the gearwheel, which can belong to the electric motor, alternatively can belong to the actuator. In other words, the actuator can have a gearwheel. The gearbox is preferably drivable by the pinion of the electric motor. The actuator can further have a printed circuit board with electric and/or electronic components, wherein the printed circuit board can be electrically connected to the stator.

All disclosures and advantages, which are described above and below in relation to the electric motor according to the first aspect of the present disclosure, are equally applicable to the actuator according to the second aspect of the present disclosure.

These and other features and advantages of the present invention will become apparent from the following description of the invention. Before the embodiments of the invention are explained in detail, it is to be understood that the invention is not limited to the details of operation set forth in the following description. The invention may be implemented in various other embodiments and of being practiced or being carried out in alternative ways not expressly disclosed herein. The use of “including” and “comprising” and variations thereof is meant to encompass the items listed thereafter and equivalents thereof as well as additional items and equivalents thereof. Further, enumeration may be used in the description of various embodiments. Unless otherwise expressly stated, the use of enumeration should not be construed as limiting the invention to any specific order or number of components. Nor should the use of enumeration be construed as excluding from the scope of the invention any additional steps or components that might be combined with or into the enumerated steps or components.

### BRIEF DESCRIPTION OF THE DRAWING

One embodiment of the invention is elucidated in more detail below with reference to the drawing. Wherein:

FIG. 1 shows an overhead view of an electric motor according to an example embodiment;

FIG. 2 shows a perspective view of an electric motor according to example embodiment;

FIG. 3 shows a perspective view of an electric motor according to example embodiment;

FIG. 4 shows a perspective view of an electric motor according to example embodiment; and

FIG. 5 shows a perspective view of an electric motor according to example embodiment.

Similar, similarly acting, identical or identically acting elements are provided with similar or identical reference numerals. The drawings are only schematic and are not to scale.

### DETAILED DESCRIPTION OF THE CURRENT EMBODIMENTS

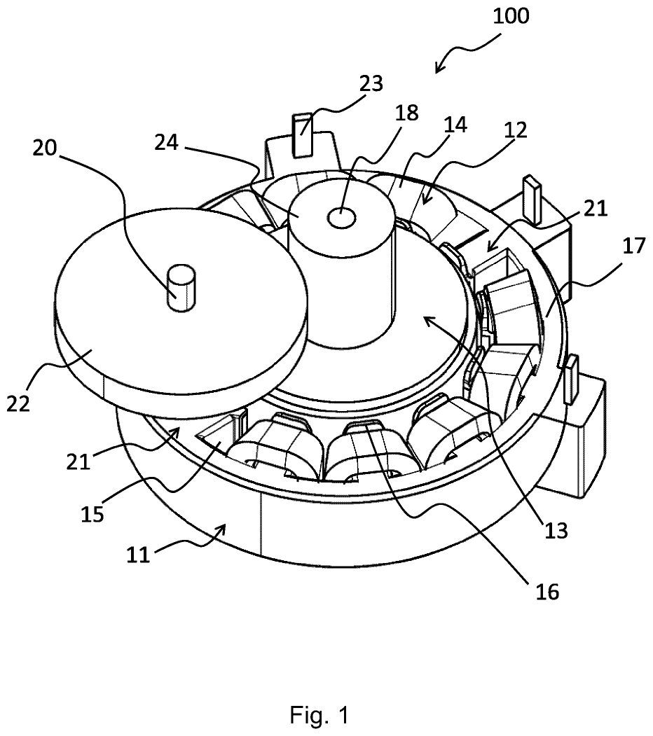

FIG. 1 shows an electric motor 100 for an actuator according to an example embodiment in an overhead view, i.e. top-down view. In this case, the electric motor 100 has a gearwheel 22. The gearwheel 22 can alternatively be part of the actuator. The electric motor 100 in FIG. 1 is preferably a direct current motor. The electric motor 100 comprises a stator 11 with a ring 17, especially an iron ring, a rotor 13 with a rotor axis 18 arranged in the stator 11 (although this is not shown in FIG. 1, as a rule, the rotor axis 18 protrudes from the pinion 24), and a plurality of electromagnets 12. Shown in this example is a bore through which the rotor axis 18 passes. The rotor 13 is stored in a housing which is not shown here. Alternatively, the rotor 13 can also be outfitted with a shaft, which can then also be stored in the housing. The electric motor 100 of FIG. 1 especially has nine electromagnets 12. Each electromagnet 12 has a coil core 16 and a coil 14 wound around the corresponding coil core 16. The ring 17 is formed monolithically with the truncated cone shaped coil core 16. The electromagnets 12 are arranged next to one another on a circular path, wherein the circular path has at least one circular arc opening 21. The circular path of FIG. 1 especially has two circular arc openings 21. Wherein the two circular arc openings 21 are arranged opposite one another in the radial direction of the stator 11. Let it be noted that it is conceivable to provide multiple circular arc openings. The electric motor 100 further has a bearing with a bearing axis 20 for the gearwheel, which is arranged in the at least one circular arc opening 21 in parallel to the rotor axis 18.

A pinion 24 is arranged on the rotor axis 18. Within the scope of this invention, the pinion 24 is assigned exclusively to the rotor 11. All other wheels of an assigned gearbox are referred to as gearwheel. The electric motor 100 can further have a printed circuit board (not shown here). The printed circuit board comprises an electric switch for controlling the coils 14 and thus the electromagnets 12 of the stator 11.

The electric motor 100 is further provided with three press-fit contacts 23. Alternatively contact lugs or soldering contacts can be used.

One of the two circular arc openings 21, that is the one in which the bearing axis 20 is arranged, has two coil cores 15 without coils. The second of the two circular arc openings 21, that is the one which is arranged, in the radial direction, opposite the first circular opening 21 has only one coil core 15 without a coil. The providing of a second circular arc opening 21 can advantageously improve the operation of the electric motor 100 or the actuator, since through that gentler or smoother movement of the rotor 13 can be enabled. However, the second (or further) circular arc opening 21 is optional.

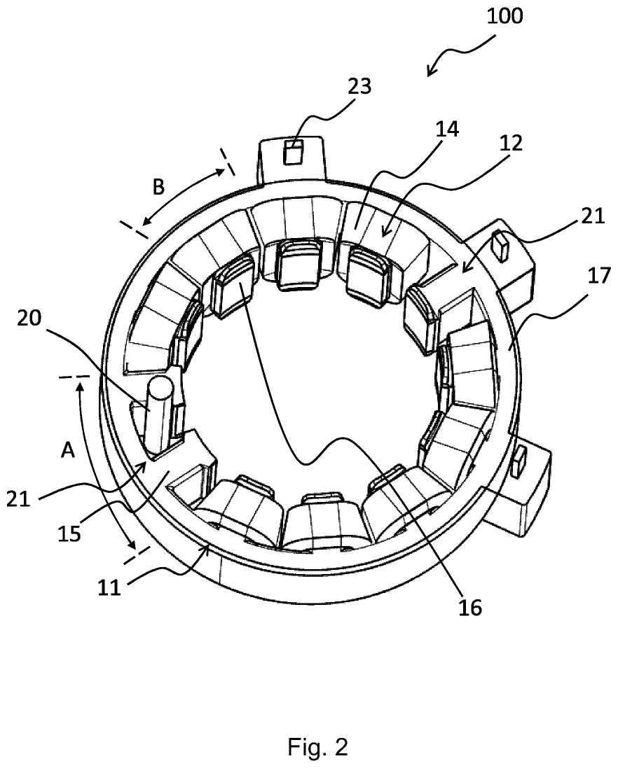

FIG. 2 shows a perspective view of an electric motor 100 of an actuator according to an example embodiment. The electric motor 100 of FIG. 2 can be the electric motor 100 of FIG. 1, in which the gearwheel 22 is not shown. The bearing with the bearing axis 20 for the gearwheel 22 is located in the (first) circular arc opening 21. For this purpose, two coils 14 of two electromagnets 12 have been omitted, so that two coil cores 15 without coils are arranged in the circular arc opening 21. By omitting two coils 14 of two electromagnets 12, sufficient space can be created for the bearing axis 20 between two coil cores 15 without coils. In this manner, the distance in the radial direction of the stator 11, or the electric motor 100, between the rotor axis 18 and the bearing axis 20 can be smaller than the radius of the ring 17 of the stator 11. Furthermore, such an arrangement of the bearing axis 20 allows the gearwheel 22 to be arranged in such a manner that it takes up less vertical space, i.e. in the axial direction of the stator 11, of the electric motor 100 than in known electric motors.

The at least one (in the present case the first) circular arc opening 21 preferably has a circular arc length A, which corresponds to the tangential width B of at least one coil 14. In the example embodiment of FIG. 2, the circular arc length A of the first circular arc opening 21 corresponds exactly to the tangential width B of two coils 14 and the circular arc length of the second circular arc opening 21 corresponds exactly to the tangential width of exactly one coil 14.

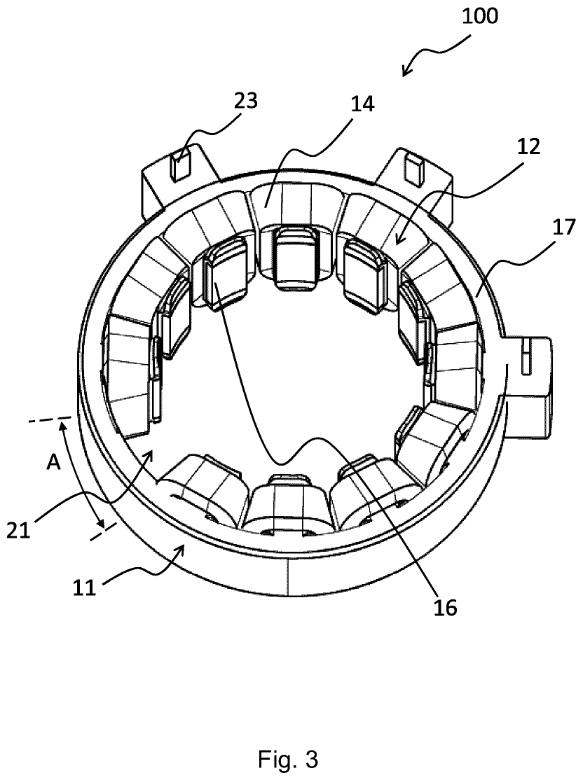

FIG. 3 shows a perspective view of an electric motor 100 according to an example embodiment, in particular according to an alternative example embodiment to FIGS. 1 and 2. In the electric motor 100 of FIG. 3, the circular arc opening 21 corresponds exactly to the space that would be occupied by a coil 14 together with the coil core 16. In the circular arc opening 21, contrary to the embodiments of FIGS. 1 and 2, there is no coil core 15 without a coil. Accordingly, instead of omitting two electromagnets, only one electromagnet 12 can be omitted in the present example embodiment. Through that, more space can be created for the bearing axis 20 than in the example embodiment in FIGS. 1 and 2. The diameter of the bearing axis 20 of the electric motor in FIG. 3 can therefore be larger than the diameter of the bearing axis 20 of the electric motor in FIGS. 1 and 2. This increases the stability and reliability of the electric motor 100.

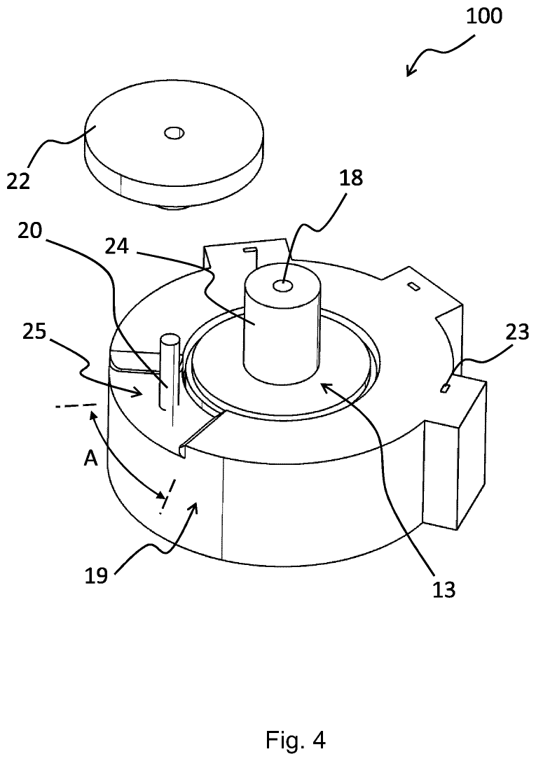

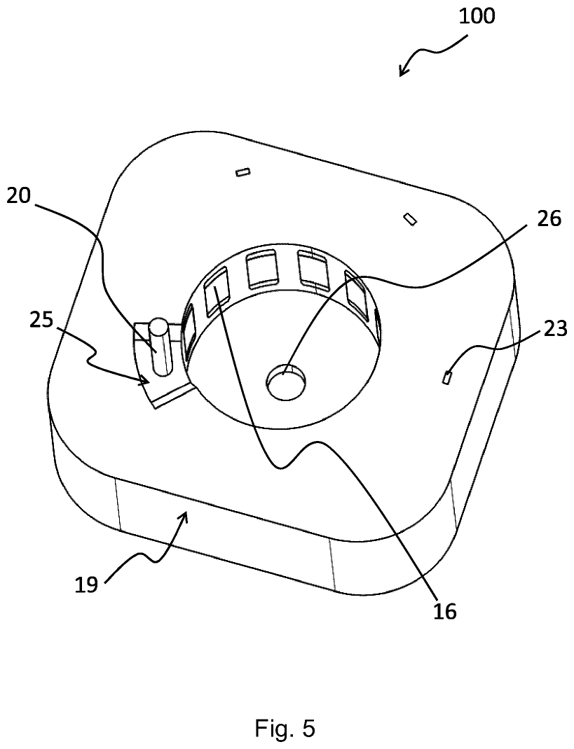

FIGS. 4 and 5 each show a perspective view of an electric motor 100 according to an example embodiment. The stator 11 of the electric motor 100 in FIGS. 4 and 5 is encapsulated with a plastic sheath 19. The sheath 19 can be a housing. With the exception of the three press-fit contacts 23, the stator 11 is surrounded by the sheath 19. Alternatively, it can be designed so that the inner diameter of the stator core is not encapsulated with plastic. The sheath 19 has a step, a recess or a notch 25 at the circular arc opening 21 of the circular path or above the circular arc opening 21. Such a step or recess in the sheath 19 serves to arrange the gearwheel 22 as close as possible to the electromagnet 12 in terms of height in order to make the electric motor as compact as possible in terms of height.

As can be seen particularly clearly in FIG. 5, the sheath 19 can have a receiving hole 26 for receiving the rotor axis 18.

In addition, let it be noted that the terms “comprise” and “have” do not exclude other elements and the indefinite articles “a” or “an” do not exclude a plurality. It should further be noted that features or steps that have been described with reference to any of the above example embodiments can also be used in combination with other features or steps of other example embodiments described above. Reference numerals in the claims are not to be considered as limitations.

### LIST OF REFERENCE NUMERALS

100 electric motor
11 stator
12 electromagnet
13 rotor
14 coil
15 coil core without a coil
16 coil core
17 ring
18 rotor axis
19 sheath
20 bearing axis
21 circular arc opening
22 gearwheel
23 press-in contacts
24 pinion
25 notch
26 receiving hole
A circular arc length of the circular arc opening
B tangential width of one coil

The above description is that of current embodiment of the invention. Various alterations and changes can be made without departing from the spirit and broader aspects of the invention. This disclosure is presented for illustrative purposes and should not be interpreted as an exhaustive description of all embodiments of the invention or to limit the scope of the claims to the specific elements illustrated or described in connection with these embodiments.

1. An electric motor for an actuator, the electric motor comprising:
a stator with a ring and a plurality of electromagnets, each of the plurality of electromagnets having a coil wound about a coil core;
a rotor arranged in the stator, the rotor having a rotor axis; and
a bearing with a bearing axis for a gearwheel, wherein the plurality of electromagnets are arranged sequentially on a circular path, wherein the circular path has at least one circular path opening, and wherein the bearing axis is arranged in the at least one circular arc opening and extends parallel to the rotor axis.

2. The electric motor of claim 1, wherein the at least one circular arc opening has a circular arc length that corresponds to a tangential width of at least one coil of the plurality of electromagnets.

3. The electric motor of claim 1, further including at least one coil core without a corresponding coil, wherein the at least one coil core without a corresponding coil is arranged in the at least one circular arc opening.

4. The electric motor of claim 3, wherein the at least one coil core without a corresponding coil has the same distance to a neighboring coil core as does two adjacent coil cores of the plurality of electromagnets.

5. The electric motor of claim 1, wherein the rotor axis coincides with a center point of the ring of the stator.

6. The electric motor of claim 3, wherein the coil cores of the plurality of electromagnets and the at least one coil core without a corresponding coil extend radially inward from an inner side of the ring of the stator.

7. The electric motor of claim 1, wherein the ring of the stator is formed monolithically with the coil cores of the plurality of electromagnets and with the at least one coil core without a corresponding coil.

8. The electric motor of claim 1, wherein:
the circular path includes two circular arc openings,
the two circular arc openings are arranged opposite of each other, and
one of the two circular arc openings comprises the at least one circular arc opening.

9. The electric motor of claim 1, wherein the stator is at least partially encapsulated with a plastic sheath, and wherein the bearing is formed within the at least partially encapsulated sheath.

10. The electric motor of claim 1, further comprising at least one gearwheel.

11. The electric motor of claim 10, wherein one drive end of the rotor is formed as a pinion, and wherein the pinion is engaged with the at least one gearwheel.

12. The electric motor of claim 1, wherein the rotor is arranged rotatably in the stator and includes a multi-polar permanent magnet.

13. An actuator comprising:
a gearbox; and
the electric motor of claim 1.
